(19) United States
(12) Patent Application Publication
(10) Pub. No.: US 2013/0159913 A1
(43) Pub. Date: Jun. 20, 2013

(54) METHOD AND APPARATUS FOR DISPLAYING AN ELECTRONIC BOOK

(71) Applicant: Samsung Electronics Co. Ltd., Suwon-si (KR)

(72) Inventor: Dujin CHA, Suwon-si (KR)

(73) Assignee: SAMSUNG ELECTRONICS CO. LTD., Suwon-si (KR)

(21) Appl. No.: 13/716,620

(22) Filed: Dec. 17, 2012

(30) Foreign Application Priority Data
Dec. 16, 2011 (KR) 10-2011-0136026

(51) Int. Cl. G06F 3/0483

(52) U.S. Cl. CPC G06F 3/0483
USPC 715/776

(57) ABSTRACT

An apparatus and method for displaying an electronic book are provided. The method includes displaying a content image for a random page of the electronic book, detecting a tilt of the terminal, and displaying an amount image that shows a position of the random page from among all pages of the electronic book, adjacently to the content image, wherein a side on which the content image and the amount image meet is determined depending on the tilt of the terminal.

### PRIORITY

This application claims the benefit under 35 U.S.C. §119(a) of a Korean patent application filed on Dec. 16, 2011 in the Korean Intellectual Property Office and assigned Serial No. 10-2011-0136026, the entire disclosure of which is hereby incorporated by reference.

### BACKGROUND OF THE INVENTION

1. Field of the Invention

The present invention relates to a method and an apparatus for displaying an electronic book. More particularly, the present invention relates to a method and an apparatus for a user to intuitively determine the position of a page and move to another page.

2. Description of the Related Art

Existing user interfaces for displaying an electronic book have a separate menu for determining the position of a page or moving to a specific page. Such user interfaces also typically include an indication showing a current page and a total number of pages. For example, a user interface may display a mark such as 100/546, which means that the current page is page 100 in a total of 546 pages. Such indications are typically displayed at the top of the page to allow a user to determine the position of the page in relation to the total number of pages. In order to move to a specific page, the user must go through a process of searching a page by typing in the page number or clicking the table of contents. However, when the user is not familiar with the electronic book software, this method causes difficulty in determining the position of a page or moving to a specific page. Furthermore, the screen layouts for the user interfaces are complicated, therefore causing a problem of decreasing the overall readability.

Therefore, a need exists for an improved apparatus and method that allows a user to more easily navigate an electronic book.

### SUMMARY OF THE INVENTION

Aspects of the present invention are to address at least the above-mentioned problems and/or disadvantages and to provide at least the advantages described below. Accordingly, an aspect of the present invention is to provide an interface to allow a user to intuitively determine the number of pages before and after the current page, depending on the tilt of the terminal.

Another aspect of the present invention is to provide a method and an apparatus for displaying an electronic book in which the user can move to another page simply with intuitive operations.

In accordance with an aspect of the present invention, a method for displaying an electronic book on a terminal is provided. The method includes displaying a content image for a random page of the electronic book, detecting a tilt of the terminal, and displaying an amount image that shows a position of the random page from among all pages of the electronic book, adjacently to the content image, wherein a side on which the content image and the amount image meet is determined depending on the tilt of the terminal

In accordance with another aspect of the present invention, an apparatus for displaying an electronic book on a terminal is provided. The apparatus includes an input unit configured to receive a user's input, a display unit configured to display a content image for a random page of an electronic book, a sensor configured to detect a tilt of the terminal, and a controller configured to control to display an amount image that shows a position of the random page from among all pages of the electronic book, adjacently to the content image when the sensor detects the tilt of terminal, and configured to determine a side on which the content image and the amount image meet, depending on a tilted direction of the terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating an internal structure of an electronic book display apparatus according to an exemplary embodiment of the present invention;

FIG. 2 is a flowchart illustrating a process of displaying an amount image of an electronic book and moving to another page according to an exemplary embodiment of the present invention;

FIG. 3 is a flowchart illustrating a process for displaying a content image according to an exemplary embodiment of the present invention;

FIG. 4 is a flowchart illustrating a process for displaying an amount image when a content image is displayed on a single page according to an exemplary embodiment of the present invention;

FIG. 5 is a flowchart illustrating a process for displaying an amount image when a content image is displayed on both pages according to an exemplary embodiment of the present invention;

FIG. 6 is a flowchart illustrating a process for moving to another page according to an exemplary embodiment of the present invention;

FIG. 7 is a flowchart illustrating a process of receiving a page move input by enlarging and displaying the amount image when the tilt angle of a terminal becomes larger according to an exemplary embodiment of the present invention;

FIG. 8 is a flowchart illustrating a process of displaying and editing a memo for the information of the electronic book while displaying the amount image according to an exemplary embodiment of the present invention;

FIG. 9 is a view illustrating a content image from a single-page version to a both-pages version, or vice versa, depending on the rotation of a terminal according to an exemplary embodiment of the present invention;

FIG. 10 is a view illustrating an amount image depending on the tilt of a terminal when the content image is displayed on a single page according to an exemplary embodiment of the present invention;

FIG. 11 is a view illustrating an amount image depending on the tilt of a terminal when the content image is displayed on both pages according to an exemplary embodiment of the present invention;

FIG. 12 is a view illustrating graphic interfaces for bookmark or chapter images according to exemplary embodiments of the present invention;

FIG. 13 is a view illustrating graphic interfaces that allow a user to move to another page after receiving a page move input according to an exemplary embodiment of the present invention;

FIG. 14 is a view illustrating graphic interfaces for editing a memo according to an exemplary embodiment of the present invention; and

FIG. 15 is a view illustrating graphic interfaces for enlarging and displaying an amount image when the tilt angle of a terminal becomes larger according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In this document, the term “content image” refers to the display of the content contained on a random page of an electronic book. Also, in this document, the term “amount image” refers to the display of the position of the current page from among all pages of an electronic book and includes display of the number of pages before and/or after the current page.

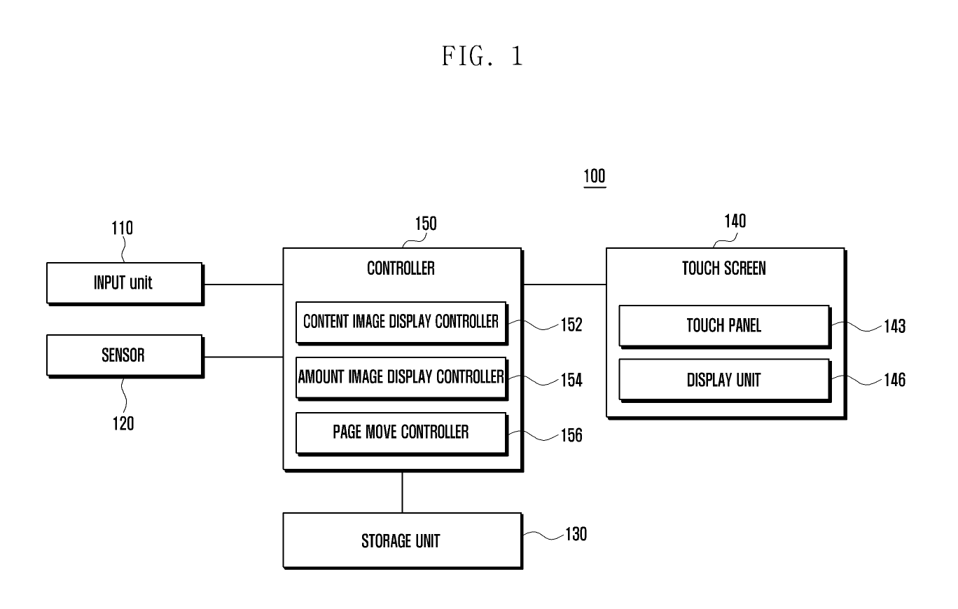

FIG. 1 is a block diagram illustrating an internal structure of an electronic book display apparatus according to an exemplary embodiment of the present invention.

Referring to FIG. 1, an electronic book display apparatus 100 includes an input unit 110, a sensor 120, a storage unit 130, a touch screen 140, and a controller 150.

The input unit 110 receives a user's input to control the terminal 100, generates an input signal, and transmits the signal to the controller 160. In an exemplary embodiment of the present invention, the input operations of the terminal 100 can be performed using the touch screen 140. In this case, a touch panel 143 can perform the functions of the input unit 110.

The sensor 120 detects a rotation or a tilt of the terminal 100, and may include a gyro sensor or an acceleration sensor. In an exemplary embodiment, the sensor 120 detects a rotation or a tilt of the terminal 100 and transmits a signal to the controller 150.

The storage unit 130 performs a function of storing programs and data required for operations of the terminal 100, and may be divided into a program area and a data area. In the program area, programs for controlling operations of the terminal 100 and applications for the execution of an electronic book can be stored. In the data area, data produced during the use of the terminal 100 can be stored, and can contain data like the content of the electronic book.

The touch screen 140 includes the touch panel 143 and a display unit 146. The touch panel 143 detects a user's touch input, generates a detection signal and transmits the signal to the controller 150. The detection signal includes coordinate data regarding a user's touch point. When the user inputs a movement of the position of the touch point, the touch panel 143 generates a detection signal that includes coordinate data of the movement route of the touch point, and transmits the signal to the controller 150.

More particularly, the touch panel 143 can detect a page move command for moving to another page, a page determination command for determining a page, or a page edit command for editing a memo, according to an exemplary embodiment of the present invention. In an exemplary implementation, the sensor 120 that detects a rotation or a tilt of the terminal 100 and the touch panel 143 that detects a user's touch input are illustrated as separate blocks for technical convenience.

The display unit 146 visually provides a user with various information such as the menu of the terminal 100, entered data, and setting information for each function. In an exemplary embodiment of the present invention, the display unit 146 performs a function of displaying the content image and the amount image in particular.

The controller 150 controls operations for each component of the terminal 100. In an exemplary implementation, the controller 150 can control a series of operations. For example, the controller 150 can control displaying of the content image, displaying of the amount image depending on the tilt of the terminal 100, receiving of a page move input, moving to a specific page and displaying of the page. The controller 150 according to an exemplary embodiment of the present invention can also include a content image display controller 152, an amount image display controller 154, and a page move controller 156.

The content image display controller 152 controls to display content contained in a random page of the electronic book. According to an exemplary embodiment of the present invention, the content image can be displayed on a single page or both pages. The content image display controller 152 controls to modify the content image from a single-page version to a both-pages version, or vice versa, depending on the rotation of the terminal 100 and display the modified content image. An exemplary method for handling graphic interfaces for displaying the content image will be explained later.

The amount image display controller 154 controls to display an amount image adjacently to the content image depending on the tilt of the terminal 100. For example, if a user tilts the terminal 100 to the right, the amount image display controller 154 controls to display the amount of pages before the current page on the left of the content image.

Furthermore, if the tilt angle of the terminal becomes larger, the amount image display controller 154 can control to enlarge and display the amount image. Also, the amount image display controller 154 can control to display the information of the electronic book, such as bookmark or chapter images as a part of the amount image. An exemplary method for handling graphic interfaces for displaying the amount image will be explained later.

The page move controller 156 controls to determine if a user's input received from the input unit 110 is a page move command and if so, controls to move to another page of the user's choice and display the page reached after the page move. For example, if the user touches a bookmark image, the page move controller 156 can control to move to the page linked with the bookmark and display the bookmarked page.

The above description that the controller 150, the content image display controller 152, the amount image display controller 154, and the page move controller 156 are separate blocks and each block performs different functions is for technical convenience. That is, the function of each block is not necessarily distinct from one another as such. For example, it should be noted that a specific function of the page move controller 156 can be performed by the controller 150 itself.

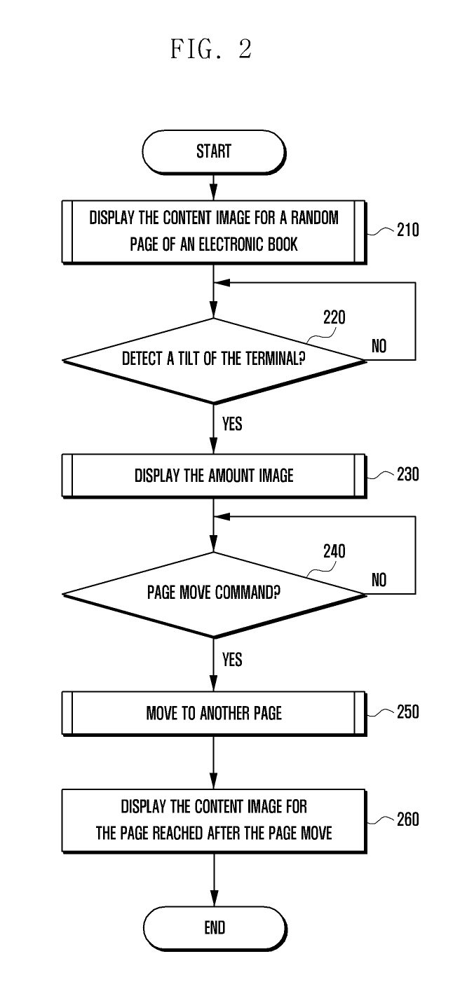

FIG. 2 is a flowchart illustrating a process of displaying an amount image of an electronic book and moving to another page according to an exemplary embodiment of the present invention.

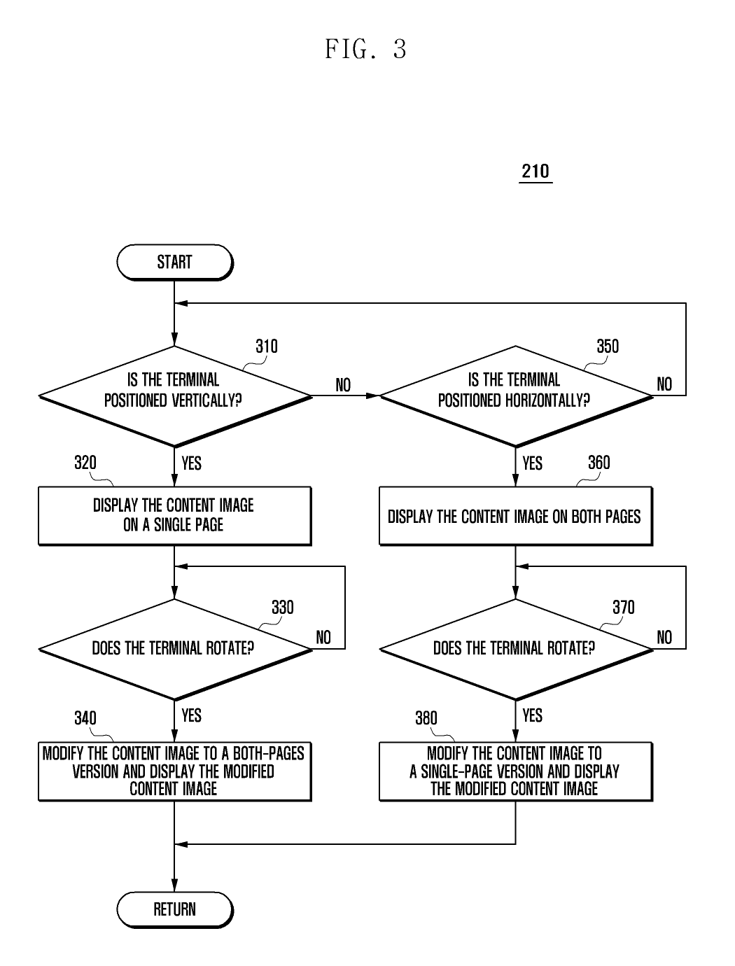

Referring to FIG. 2, the controller 150 of the terminal 100 controls the display unit 146 to display the content image in step 210. The content image can be displayed on a single page or both pages. The content image can be modified and displayed depending on the rotation of the terminal. A more detailed explanation of this process is illustrated in FIG. 3.

FIG. 3 is a flowchart illustrating a process for displaying a content image according to an exemplary embodiment of the present invention.

Referring to FIG. 3, if it is determined that the terminal is positioned vertically in step 310, the controller 150 displays the content image on a single page in step 320. However, if it is determined that the terminal is positioned horizontally in step 350, the controller 150 displays the content image on both pages in step 360.

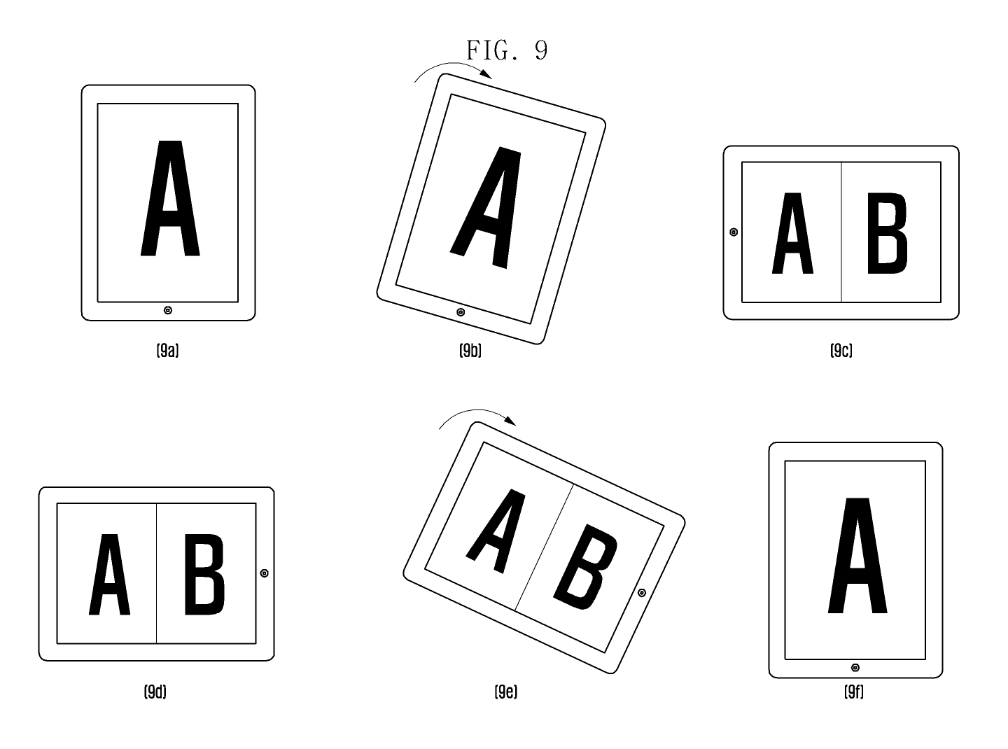

When the sensor 120 detects a rotation of the terminal, the controller 150 can control to modify and display the content image. More specifically, if a rotation of the terminal from vertical to horizontal is detected in step 330, the controller 150 controls to modify the content image from a single-page version to a both-pages version and display the modified content image in step 340. However, if a rotation of the terminal from horizontal to vertical is detected in step 370, the controller 150 controls to modify the content image from a both-pages version to a single-page version and display the modified content image in step 380. An example in which, depending on a rotation of the terminal, the content image is modified from a single-page version to a both-pages version, or vice versa, and then displayed is illustrated in FIG. 9.

FIG. 9 is a view illustrating a content image from a single-page version to a both-pages version, or vice versa, depending on the rotation of a terminal according to an exemplary embodiment of the present invention.

Referring to FIG. 9, when the terminal 100 is positioned vertically as illustrated in screen 9a, the content image is displayed on a single page. If the terminal 100 rotates from vertical to horizontal as illustrated in screen 9b, the content image is displayed on both pages as illustrated in screen 9c.

As illustrated in screen 9d, when the terminal 100 is positioned horizontally, the content image is displayed on both pages. If the terminal 100 rotates from horizontal to vertical as illustrated in screen 9e, the content image is modified and displayed on a single page as illustrated in screen 9f.

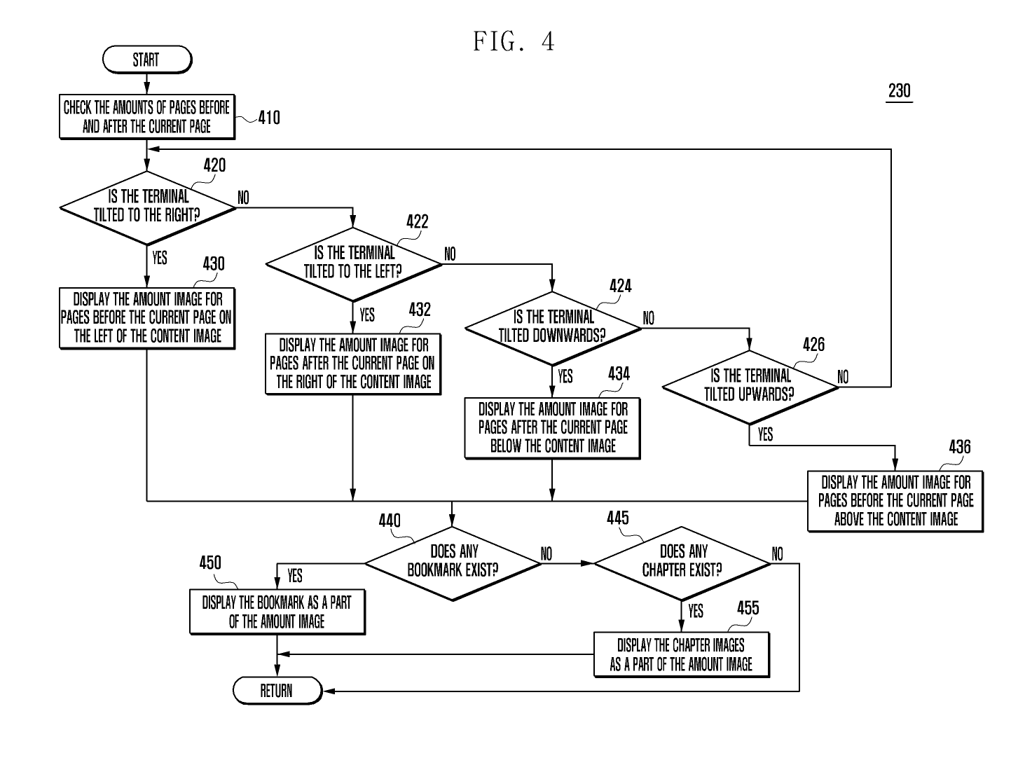

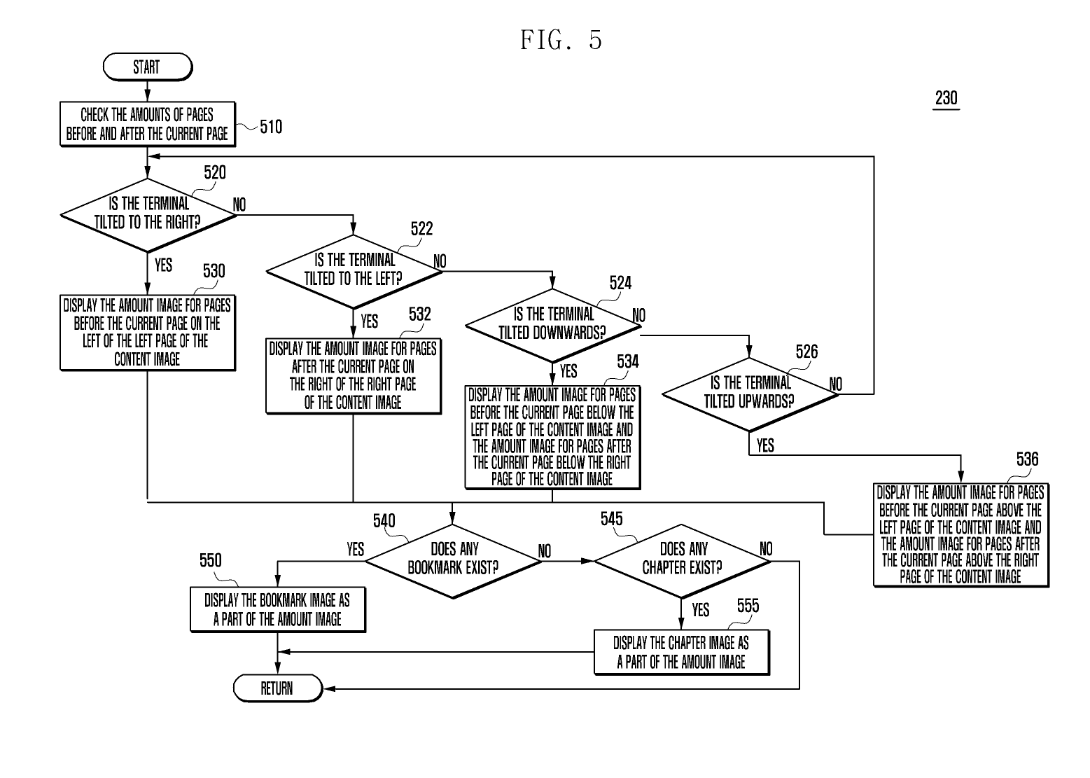

Returning to the explanation of FIG. 2, the sensor 120 determines if a tilt of the terminal 100 is detected in step 220. If a tilt of the terminal is detected in step 220, the controller 150 receives a detection signal from the sensor 120 and displays the amount image. A more detailed explanation of this process is provided in FIGS. 4 and 5.

FIG. 4 is a flowchart illustrating a process for displaying an amount image when a content image is displayed on a single page according to an exemplary embodiment of the present invention.

Referring to FIG. 4, the controller 150 determines the number of pages before and after the current page to display the amount image in step 410. For example, if the electronic book has a total of 150 pages and the current content image displayed on the screen of the terminal is for page 50, the number of pages before the current page is 49 pages and the number of pages after the current page is 100 pages. This mechanism is to provide interfaces in which the number of pages before and after the current page are intuitively recognized as in a real book.

In steps 420 to 426, the controller 150 displays the amount image adjacently to the content image depending on the tilt of the terminal. Namely, when the sensor 120 detects a right tilt of the terminal in step 420, the controller 150 displays the number of pages before the current page on the left of the content image in step 430. However, when the sensor 120 detects a left tilt of the terminal in step 422, the controller 150 displays the number of pages after the current page on the right of the content image in step 432.

When the sensor 120 detects a down tilt of the terminal in step 424, the controller 150 displays the number of pages after the current page below the content image in step 434. When the sensor 120 detects an up tilt of the terminal in step 426, the controller 150 displays the number of pages before the current page above the content image in step 436.

Steps 440 to 455 in FIG. 4 illustrate a process of including information of the electronic book, such as bookmark or chapter images, in the amount image and displaying the modified amount image. That is, the controller 150 determines if any bookmark exists in step 440, and if so, the controller 150 displays bookmark images on the amount image in step 450. In an exemplary embodiment of the present invention, bookmark images may be displayed as icons.

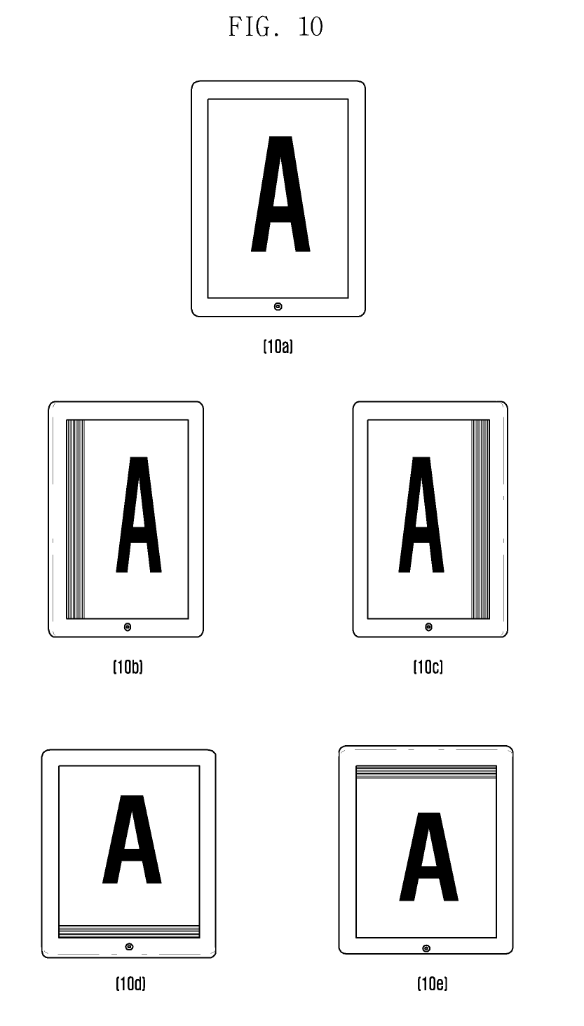

The controller 150 determines if the electronic book is divided into chapters in step 445, and if so, the controller 150 displays chapter images on the amount image in step 455. In an exemplary embodiment of the present invention, chapter images may be displayed as icons or lines included in the amount image. Examples of displaying the amount image depending on the tilt of the terminal when the content image is displayed on a single page are illustrated in FIG. 10.

FIG. 10 is a view illustrating an amount image depending on the tilt of a terminal when the content image is displayed on a single page according to an exemplary embodiment of the present invention.

Referring to FIG. 10, when the content image is displayed on a single page as illustrated in screen 10a, if the user tilts the terminal to the right, the amount image for pages before the current page is displayed on the left of the content image as illustrated in screen 10b. However, if the user tilts the terminal to the left, the amount image for pages after the current page is displayed on the right of the content image as illustrated in screen 10c.

If the user tilts the terminal downwards, the amount image for pages after the current page is displayed below the content image as illustrated in screen 10d. However, if the user tilts the terminal upwards, the amount image for pages before the current page is displayed above the content image as illustrated in screen 10e.

FIG. 5 is a flowchart illustrating a process for displaying an amount image when a content image is displayed on both pages according to an exemplary embodiment of the present invention.

Referring to FIG. 5, the process in which the controller displays the amount image is substantially the same as in FIG. 4. However, steps 530, 532, 534, and 536 include differences. To be more specific, when a right tilt of the terminal 100 is detected in step 520, the controller 150 displays the number of pages before the current page on the left of the left page of the content image in step 530. However, when a left tilt of the terminal 100 is detected in step 522, the controller 150 displays the number of pages after the current page on the right of the right page of the content image in step 532.

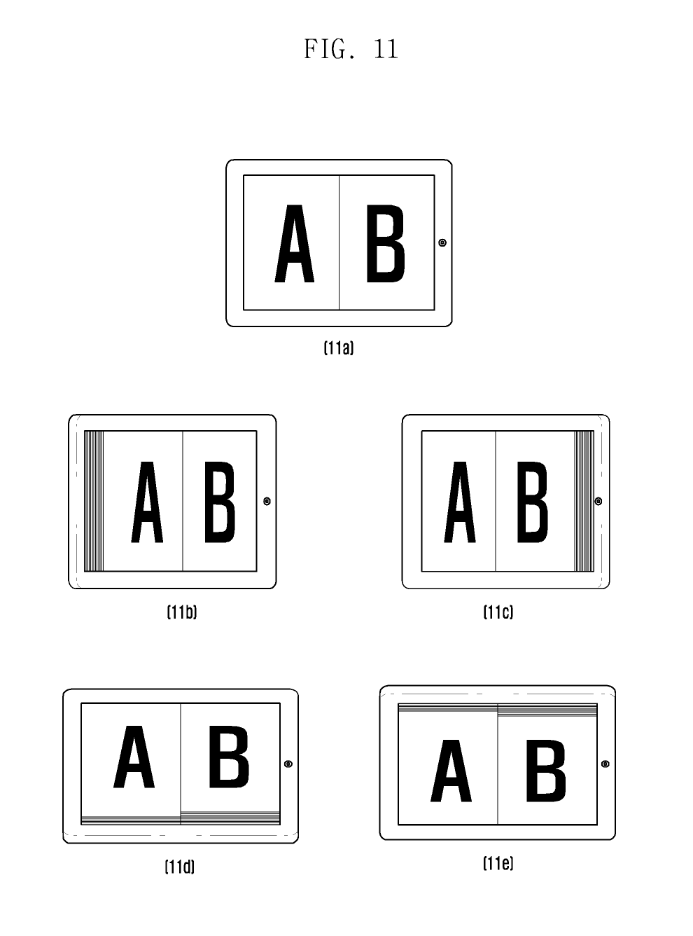

When a down tilt of the terminal 100 is detected in step 524, the controller 150 displays the number of pages before the current page below the left page of the content image and the number of pages after the current page below the right page of the content image in step 534. However, when an up tilt of the terminal 100 is detected in step 526, the controller 150 displays the amount of pages before the current page above the left page of the content image and the amount of pages after the current page above the right page of the content image in step 536. Examples of displaying the amount image depending on the tilt of the terminal when the content image is displayed on both pages are illustrated in FIG. 11.

FIG. 11 is a view illustrating an amount image depending on the tilt of a terminal when the content image is displayed on both pages according to an exemplary embodiment of the present invention.

Referring to FIG. 11, when the content image is displayed on both pages as illustrated in screen 11a, if the user tilts the terminal to the right, the amount image for pages before the current page is displayed on the left of the left page of the content image as illustrated in screen 11b. However, if the user tilts the terminal to the left, the amount image for pages after the current page is displayed on the right of the right page of the content image as illustrated in screen 11c.

If the user tilts the terminal downwards, the amount image for pages before the current page is displayed below the left page of the content image and the amount image for pages after the current page is displayed below the right page of the content image as illustrated in screen 11d. However, if the user tilts the terminal upwards, the amount image for pages before the current page is displayed above the left page of the content image and the amount image for pages after the current page is displayed above the right page of the content image as illustrated in screen 11e.

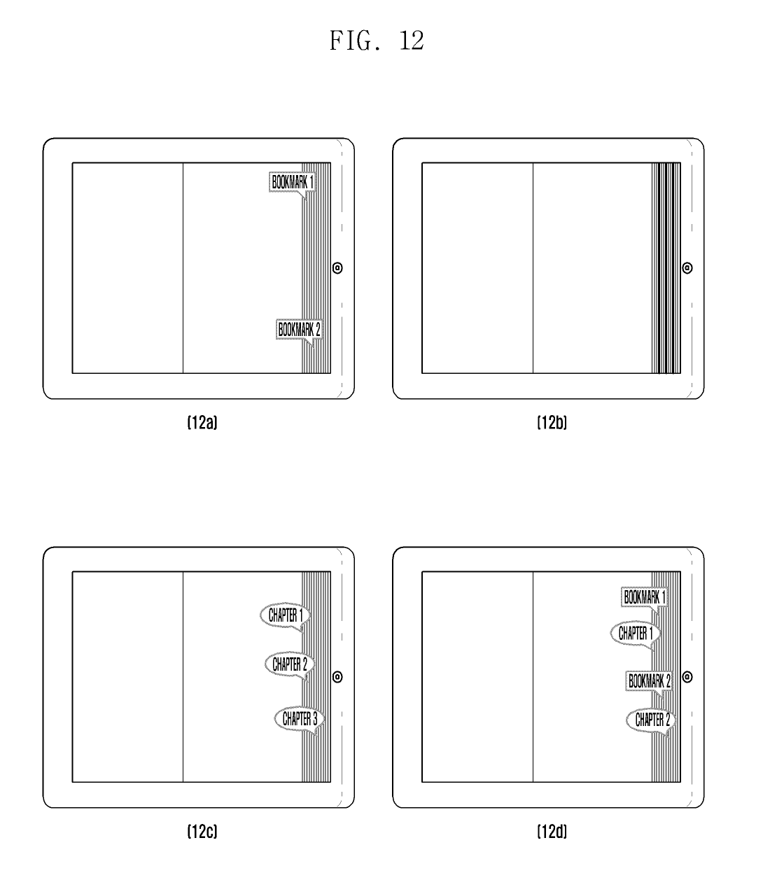

FIG. 12 is a view illustrating graphic interfaces for bookmark or chapter images according to exemplary embodiments of the present invention.

Referring to FIG. 12, screen 12a is an example of displaying bookmark images as icons. Screen 12b is an example of displaying chapter images as lines on the amount image, and screen 12c is an example of displaying chapter images as icons of different shapes along with bookmark icons. Screen 12d is a view illustrating an example of displaying both the bookmark images and the chapter images.

Returning to the explanation of FIG. 2, in step 240, the controller 150 determines if the user's input that the input unit 110 has received is a page move command for moving to another page.

Page move commands may exist in various forms. For example, the controller 150 can set a touch input on the amount image followed by a drag input towards the content image as a page move command. For another example, the controller 150 can set a touch input on the amount image followed by a touch release input as a page move command.

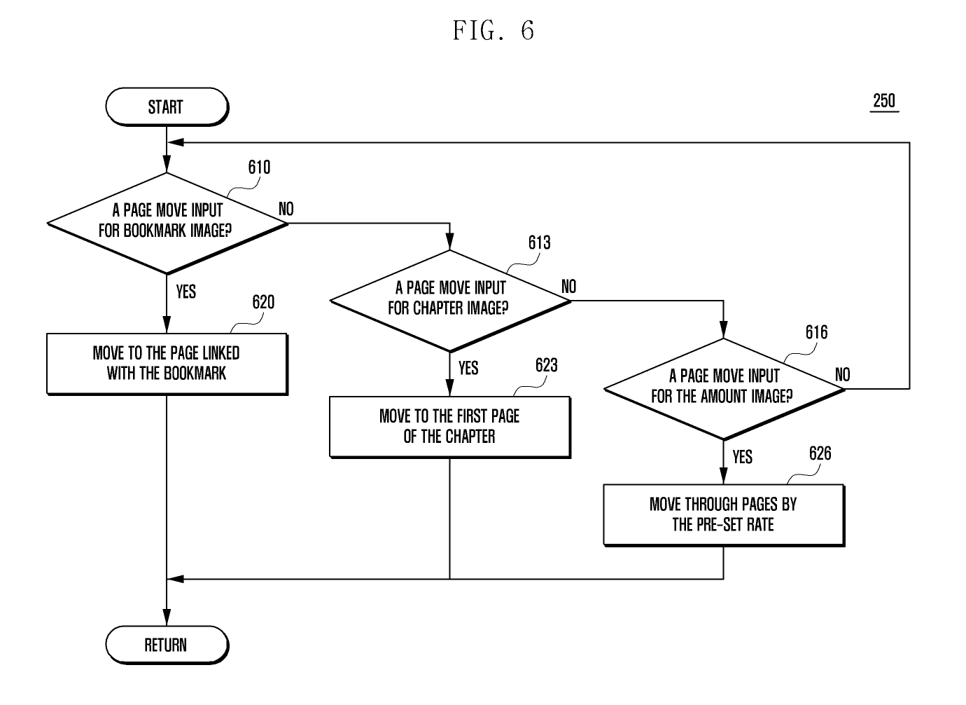

When receiving these page move commands, the controller 150 controls to move to another page in step 250 and display the content image for the page reached after the page move in step 260. An exemplary process of receiving a page move input and moving to the corresponding page is illustrated in FIG. 6.

FIG. 6 is a flowchart illustrating a process for moving to another page according to an exemplary embodiment of the present invention.

Referring to FIG. 6, if the input unit 110 receives a page move command for a bookmark image in step 610, the controller 150 interprets this command as a page move command to move to the page linked with the bookmark. The controller 150 can pre-set such a page move command as a touch input on a bookmark icon followed by a drag input towards the content image or a touch input on a bookmark icon followed by a touch release input. When receiving a page move command, the controller 150 moves to the page linked with the bookmark in step 620.

However, when the input unit 110 receives a page move command for chapter images in step 613, the controller 150 interprets this command as a page move command to move to the first page of the chapter. Therefore, the controller 150 moves to the first page of the chapter in step 623.

Step 616 is the case in which the input unit 110 receives a page move command for the amount image, not bookmark or chapter images. In this case, the controller 150 moves through pages by the pre-set rate in step 626.

For example, when receiving a page move command for the amount image for pages before the current page, the controller 150 can control to move forward 10 pages from the current page. For another example, when receiving a page move command for the amount image for pages after the current page, the controller 150 can control to move backward 10 pages from the current page.

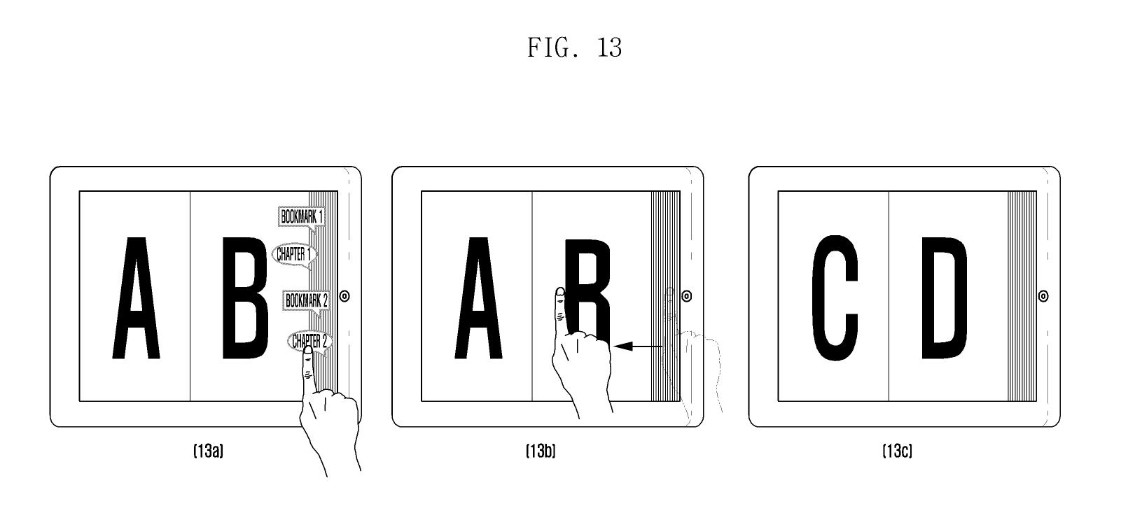

Returning to the explanation of FIG. 2, in step 260, the controller 150 controls the display unit 146 to display the content image for the page reached after the page move. Examples of graphic interfaces for moving to another page after receiving a page move input are illustrated in FIG. 13.

FIG. 13 is a view illustrating graphic interfaces that allow a user to move to another page after receiving a page move input according to an exemplary embodiment of the present invention.

Referring to FIG. 13, screen 13a is an example illustrating a page move command for bookmark or chapter images. If the user makes a touch input on a bookmark or chapter icon, the controller 150 interprets this input as a page move command to move to the page linked with the bookmark or the first page of the chapter. The controller 150 displays the content image for the page reached after the page move as in screen 13c.

Screen 13b is an example illustrating a page move command for the amount image, not bookmark or chapter images. If the user makes a touch input on the amount image for pages after the current page followed by a drag input towards the content image, the controller 150 interprets this input as a page move command to move forward 10 pages from the current page. The controller 150 displays the content image for the page reached after the page move as in screen 13c.

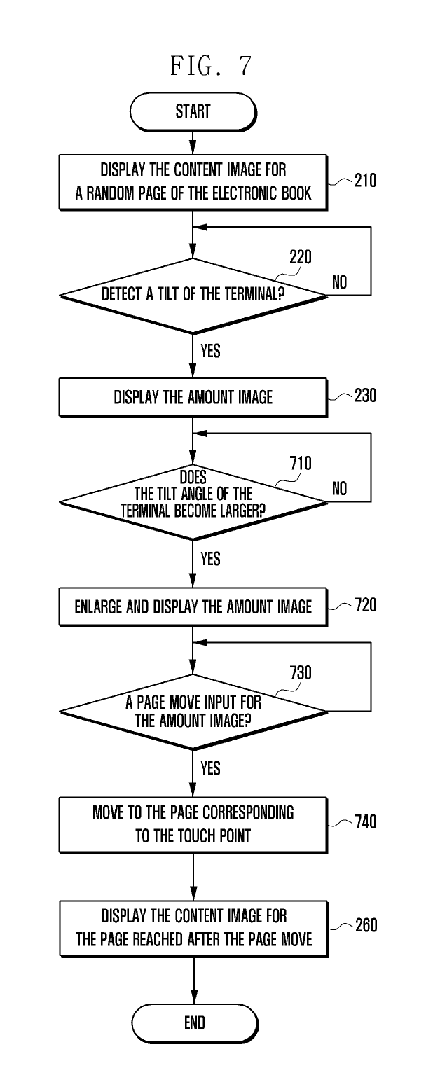

FIG. 7 is a flowchart illustrating a process of receiving a page move input by enlarging and displaying the amount image when the tilt angle of the terminal becomes larger according to an exemplary embodiment of the present invention. If the amount image is enlarged and displayed, the page move function becomes more powerful because coordinates of the touch point for the page move command for the amount image can be subdivided.

Referring to FIG. 7, the process starts with step 210 of FIG. 2 followed by steps 220 and 230. Namely, FIG. 7 starts when the controller 150 displays the amount image on the display unit 146 depending on the tilt of the terminal.

The controller 150 receives a signal that the tilt angle of the terminal has become larger from the sensor 120 in step 710. Then, the controller 150 controls the display unit 146 to enlarge and display the amount image in step 720. The controller 150 determines if the user's input received by the input unit 110 corresponds to a page move command in step 730. Namely, when the user touches a random point on the amount image or makes a touch input on a random point followed by a drag input towards the content image, the controller 150 analyzes the coordinate data of the touch point on the amount image and determines the page corresponding to the touch point in step 740.

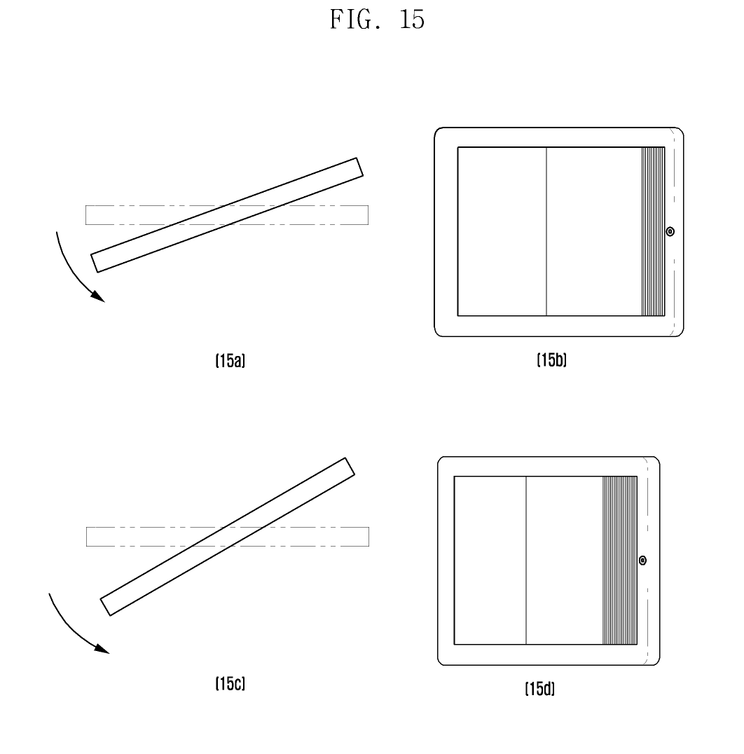

For example, when the number of pages after the current page is 100 pages and the amount image is displayed in the width of 10 cm, if the touch point for a page move command is 5 cm from the side, the page corresponding to the page move command is page 50 or later. An example of enlarging and displaying the amount image when the tilt angle of the terminal becomes larger is illustrated in FIG. 15.

FIG. 15 is a view illustrating graphic interfaces for enlarging and displaying an amount image when the tilt angle of a terminal becomes larger according to exemplary embodiments of the present invention.

Referring to FIG. 15, when the terminal is tilted to the left as illustrated in screen 15a, the amount image for pages after the current page is displayed on the right of the right page of the content image as illustrated in screen 15b. When the tilt angle of the terminal becomes larger as illustrated in screen 15c, the amount image becomes bigger as illustrated in screen 15d.

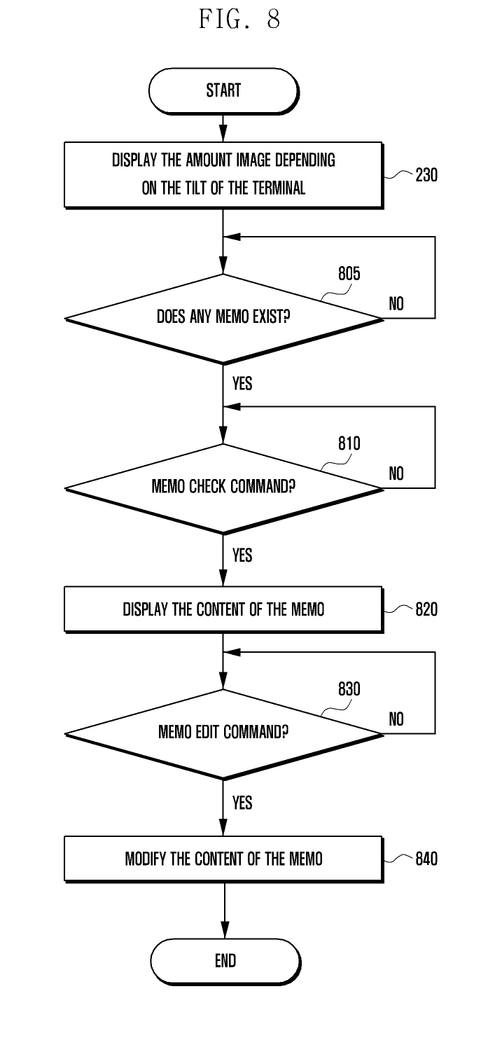

FIG. 8 is a flowchart illustrating a process of displaying and editing a memo for the information of the electronic book while displaying the amount image according to an exemplary embodiment of the present invention.

Referring to FIG. 8, the process starts with step 230 of FIG. 2. In step 230, if the controller 150 displays the amount image depending on the tilt of the terminal 100, the amount image can include bookmark or chapter images.

If a memo that the user has entered exists in step 805, the controller 150 determines if the user's input received by the input unit 110 corresponds to a memo check command in step 810. In an exemplary embodiment of the present invention, a memo check command can be a touch input on a bookmark icon for a certain amount of time. If the user's input is a memo check command, the controller 150 controls the display unit 146 to display the content of the memo in step 820. In an exemplary implementation, the display of the content of the memo may be in the form of a pop-up window.

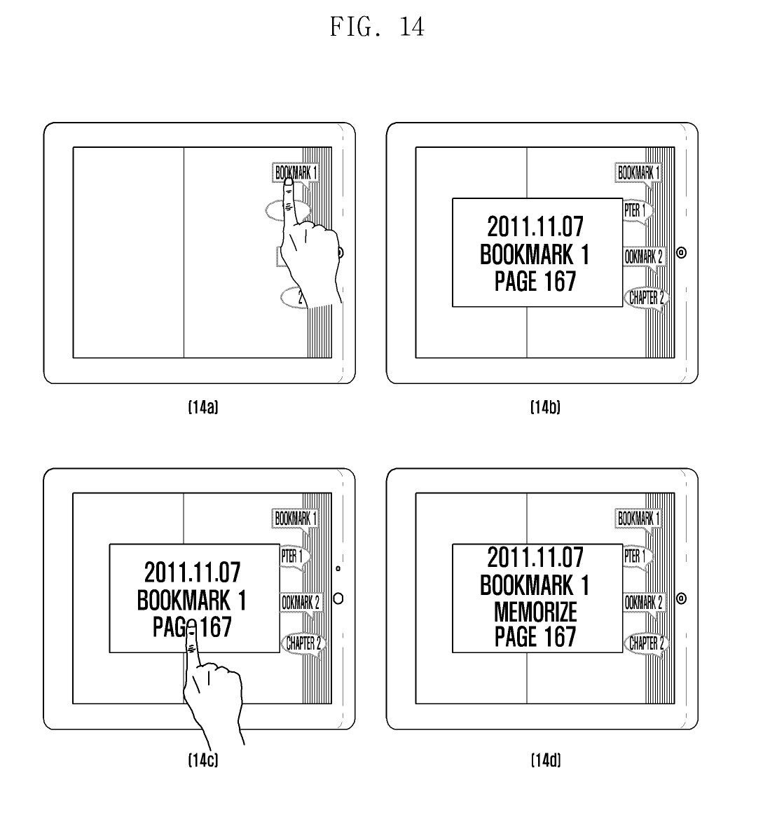

The controller 150 determines if the user's input received by the input unit 110 corresponds to a memo edit command in step 830. In an exemplary embodiment of the present invention, a memo edit command can be a touch input on a pop-up window for a memo. If the user's input corresponds to a memo edit command, the input unit 110 receives an input for editing the memo content, and the controller 150 modifies and displays the memo content, and stores the content in the storage unit 130 in step 840. An example of detailed graphic interfaces for determining and editing a memo is illustrated in FIG. 14.

FIG. 14 is a view illustrating graphic interfaces for editing a memo according to an exemplary embodiment of the present invention.

Referring to FIG. 14, screen 14a is a view illustrating the reception of a memo check command. If the user makes a touch input on a bookmark icon for a certain amount of time as illustrated in screen 14a, a pop-up window comes up and displays the content of the memo linked with the bookmark icon as illustrated in screen 14b.

Screen 14c is a view illustrating the reception of a memo edit command. If the user makes a touch input on the memo pop-up window as illustrated in screen 14c, the user can modify the memo content as illustrated in screen 14d.

According to exemplary aspects of the present invention, without the display of a separate menu or the position of a page, the user can intuitively determine the position of the current page, i.e. tilting the terminal. Also according to exemplary embodiments of the present invention, the user can move to another page only by an input for bookmark or chapter images. Therefore, the user can intuitively recognize the method for determining the position of a page of an electronic book and moving to another page.

Also, according to exemplary embodiments of the present invention, compensatory services for media content can be provided and acquired, on condition of the check-in information that attests the playback of specific media content.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for displaying an electronic book on a terminal, the method comprising:
displaying a content image for a random page of electronic book;
detecting a tilt of the terminal; and
displaying an amount image that shows a position of the random page from among all pages of the electronic book, adjacently to the content image,
wherein a side on which the amount image and the content image meet is determined depending on the tilt of the terminal

2. The method according to claim 1, further comprising:
receiving a page move command for the amount image; and
moving to another page of the electronic book and displaying the content contained in the page reached after the page move.

3. The method according to claim 2, wherein the displaying of the amount image comprises displaying the image for information of the electronic book along with the amount image, and wherein the image for the information of the electronic book comprises at least one of a bookmark image and a chapter image of the electronic book.

4. The method according to claim 3, wherein the receiving of the page move command comprises receiving a page move input for the at least one the bookmark and the chapter image, and
the moving to the other page comprises:
moving to at least one of a page linked with the bookmark and a first page of the chapter; and
displaying content contained in the page reached after the page move.

5. The method according to claim 2, wherein the moving to the other page comprises:
moving through pages by a pre-set rate; and
displaying content contained in a page reached after the page move.

6. The method according to claim 1, further comprising:
detecting a larger tilt of the terminal; and
enlarging and displaying the amount image.

7. The method according to claim 6, further comprising:
receiving a page move command for the enlarged amount image;
moving to a page corresponding to the page move command; and
displaying content contained in a page reached after the page move.

8. The method according to claim 1, further comprising:
receiving a memo determination command to determine a previously entered memo of the electronic book; and
displaying content of the memo.

9. The method according to claim 8, further comprising:
receiving a memo edit command to edit the memo; and
modifying and displaying the content of the memo.

10. The method according to claim 1, wherein the displaying of the content image comprises:
displaying the content image on a single page or both pages;
detecting a rotation of the terminal;
modifying the content image from a single-page version to a both-pages version, or from the both-pages version to the single-page version; and
displaying the modified content image.

11. An apparatus for displaying an electronic book, the apparatus comprising:
an input unit configured to receive a user's input;
a display unit configured to display a content image for a random page of electronic book;
a sensor configured to detect a tilt of terminal; and
a controller configured to control to display an amount image that shows a position of the random page from among all pages of the electronic book adjacently to the content image when the sensor detects the tilt of terminal, and configured to determine a side on which the amount image and the content image meet depending on a tilted direction of the terminal

12. The apparatus according to claim 11, wherein the input unit receives a user's input for the amount image, and wherein the controller determines whether the user's input is a page move command, and controls to move to another page and display content contained in the page reached after the page move when the user's input is the page move command.

13. The apparatus according to claim 12, wherein the controller controls to display the image for the information of the electronic book along with the amount image, and wherein the image for the information of the electronic book comprises at least one of a bookmark image and a chapter image of the electronic book.

14. The apparatus according to claim 13, wherein the input unit receives a user's input for the at least one of the bookmark image and the chapter image, and wherein the controller determines whether the user's input is a page move command, and controls to move to a page linked with the bookmark or a first page of the chapter and display content contained in the page reached after the page move when the user's input is the page move command.

15. The apparatus according to claim 12, wherein the controller determines whether the user's input is a page move command, and controls to move through pages by a pre-set rate and display content contained in the page reached after the page move when the user's input is the page move command.

16. The apparatus according to claim 11, wherein the sensor detects a tilt angle of the terminal, and wherein the controller controls to enlarge and display both the amount image and the content image if the tilt angle of the terminal becomes larger.

17. The apparatus according to claim 16, wherein the input unit receives the user's input for the enlarged amount image, and wherein the controller determines whether the user's input is a page move command, and controls to move to a page corresponding to the page move input and display content contained in the page reached after the page move when the user's input is the page move command.

18. The apparatus according to claim 11, wherein the controller determines whether the user's input received by the input unit is a memo determination command for determining a previously entered memo, and controls to display content of the memo when the user's input is the memo determination command.

19. The apparatus according to claim 18, wherein the controller determines whether the user's input received by the input unit is a memo edit command for modifying content of the memo, and controls to modify and display the content of the memo according to the memo edit command when the user's input is the memo edit command.

20. The apparatus according to claim 11, wherein the sensor detects a rotation of the terminal, and wherein the controller controls to display the content image on a single page or both pages, and modify the content image from a single-page version to a both-pages version, or from the both-pages version to the single-page version, and display the modified content image, depending on the rotation of the terminal.
